(19) United States
(12) Patent Application Publication
(10) Pub. No.: US 2007/0027857 A1
(43) Pub. Date: Feb. 1, 2007

(54) System and method for searching multimedia and download the search result to mobile devices

(76) Inventors: Li Deng, San Jose, CA (US); Yingging Lawrence Cui, San Jose, CA (US)

Correspondence Address: Li Deng, 1047 S. Blaney Ave, San Jose, CA, 95129, US

(21) Appl. No.: 11/494,068

(22) Filed: Jul. 27, 2006

Related U.S. Application Data
(60) Provisional application No. 60/703,102, filed on Jul. 28, 2005.

(51) Int. Cl. G06F 17/30

(52) U.S. Cl. 707/3

(57) ABSTRACT

A method and system for searching multimedia files from multimedia content sites on the internet and downloading search result to mobile devices. The system and method includes a crawling server for indexing multimedia items, a search server, a data storage server, a download server and a wireless messaging server in data communication with the internet and in wireless communication with SS7 wireless networks, and a wireless mobile device having circuitry for establishing data communications with the wireless application protocol network and a display for displaying information generated by the search server. The methods further include crawling the Internet to index multimedia items; enabling search from both desktop PC and mobile devices to find desired multimedia items; providing options to send search result to mobile devices; downloading search result directly on a mobile device; detecting downloading method from downloading request; delivering notification message to mobile device and invoking the link on the mobile device to initiate download; creating file descriptor for downloading; and downloading the multimedia item to mobile devices.

This application is based on provisional application 60/703,102 filed on Jul. 28, 2005.

### FIELD OF THE INVENTION

The present invention relates generally to wireless mobile devices with wireless internet capabilities and multimedia capabilities, and more particularly but not exclusively to provide a scheme for enabling mobile users using a computer network such as the internet to deliver multimedia search result to their mobile devices.

### BACKGROUND OF THE INVENTION

In today's society, mobile devices are becoming increasingly more powerful. The greatest manifestation is the glue between unwired universes to the Internet domain and the advent of wireless multimedia and wireless internet capabilities. The latest mobile devices are capable of displaying high quality color photos, playing mp3, mp4 songs and playing audio, video clips. Wireless phones with embedded cameras can take photos; upload them into online albums; and save them as screensavers or wallpapers. However, there are vast libraries of multimedia such as high resolution digital photos, audios, webcam images, and videos available via internet. There are search engines such as image search, video search, and audio search available for locating these multimedia assets on the internet via desktop PCs. Users can use PC to search these multimedia assets, preview the search result, and download to their hard disks. However, these multimedia assets are generally off limits to mobile devices. There is clearly a need to provide a seamless scheme to make these multimedia assets available to multimedia capable mobile devices.

The present invention aims at providing a scheme to enable the delivery of multimedia search result to mobile devices by just one click of the search result. The present invention will make the vast libraries of multimedia exists on the internet readily available for mobile devices.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates a logical flow diagram generally showing one embodiment of a system and method for practicing the invention.

FIG. 4 illustrates one embodiment of logical components and data flow for practicing the invention, in accordance with FIG. 3.

FIG. 5 illustrates another embodiment of logical components and data flow for practicing the invention, in accordance with FIG. 3.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, un recited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention seeks to address the aforementioned problem by providing a system and method for enabling mobile users using either a computer or an internet capable mobile device to search the vast libraries of multimedia available in the internet and to have the selected search result delivered to the mobile device. More particularly, the present invention provides a system and method to enable mobile users to find or download multimedia items located on any internet server to their mobile devices. When a mobile user enters the keywords for desired multimedia items, the search engine will generate a search result list with options for the user to preview or download any item in the list. The system and method of the present invention then collect the info of the mobile device and deliver the specified multimedia item to the device.

According to an exemplary embodiment of the present invention, a system and method generally include crawling the internet sites that host multimedia items and indexing each multimedia item. A plurality of multimedia content sites are in data communication with the Internet and thus, accessible for indexing and searching. A record is created for each multimedia item indexed. The record includes the URL of the web page that contains the multimedia item, the URL pointing to the multimedia item, and the metadata that describes the multimedia item.

The system and method of the present invention stores records for every multimedia item indexed. Each record contains the URL of the multimedia item and the URL of the web page that contains the link pointing to the multimedia item. In addition, each record contains metadata of the said multimedia item including size, type, time/date, name/title, description, author/artist, genre/category and tag info. The metadata is collected by analyzing the web page, tags of the said multimedia item, and the multimedia item.

The system and method of the present invention also offers a database of wireless devices and service providers. The database has records for each device and each service provider. The device record contains information about multimedia capability including the type of multimedia that can be played on the said device, the size limitation of the said device. Device capabilities may depend on service provider as well. The service provider record contains the delivery mechanism that is mandated by a particular service provider depend on the underline wireless network used by the service provider. For example, for most CDMA carriers, a file descriptor is required to download a multimedia item to mobile devices. For some service providers, only way to download a multimedia item is via multimedia message and for others both WAP and MMS are good enough. The system and method of the present invention also provides a map that maps WAP gate way IP addresses to service providers.

The search process starts when a mobile user enters search keywords looking for related multimedia The internet server of the present invention matches search keywords with the records of indexed multimedia items and generates a list of multimedia items and corresponding records including World Wide Web links wherein such multimedia items can be located. In addition, user may also specify optional parameters such as device model, multimedia type and the like to improve the search so that only items that are supported by a given device or matching a given multimedia type will be returned. The matching multimedia items are then returned and presented to the user. The user can then browses the list, preview the multimedia items, and select a multimedia item of interest. If the search is conducted from a computer connected to internet, the system and method of the present invention provide options for mobile users to preview or send a selected item in the search result list directly to their mobile phones. After collecting the device or provider information from the mobile user, the system and method of the present invention delivers a notification message with a web link. The notification message can be implemented as a SMS message, a WAP Push message or a like. Mobile users can then follow the link in the notification message to retrieve the multimedia item. If the search is conducted from a wireless internet ready mobile device, the system and method of the present invention provide options to preview or download right from the wireless internet search session. After selecting a search result, the mobile user can download and save the multimedia item right from the mobile device.

In one embodiment, after successfully collecting the device info and making sure the multimedia item is compatible with the said device by querying the device database of the present invention, the server of the present invention sends a SMS message with a short url that can be invoked to download the selected multimedia item. The mobile user can then start downloading the multimedia item by invoking the url in the SMS message. The server, upon receiving the download request, generates a file descriptor for the download if required and then redirects the request to the internet server that hosts the multimedia item. The redirect is necessary even though a file descriptor is not required since many multimedia urls are very long which exceed the message size limitation of 140 characters for most handsets. The multimedia item is downloaded directly from the remote internet server to the said mobile device. The multimedia item can then be played and saved on mobile devices. In another embodiment, after successfully collecting the device info, the server of the present invention fetches the multimedia item from the remote server and then sends the multimedia directly to the said device via a multimedia message.

In yet another embodiment, the search is conducted from the wireless internet capable device. The device information is collected directly from the profile supplied with the request. The search server returns result list supported by the said device. The user then uses the appropriate soft keys on the mobile device to browse the list, preview the multimedia items, and download multimedia items of interest right on the mobile device.

Illustrative Operating Environment

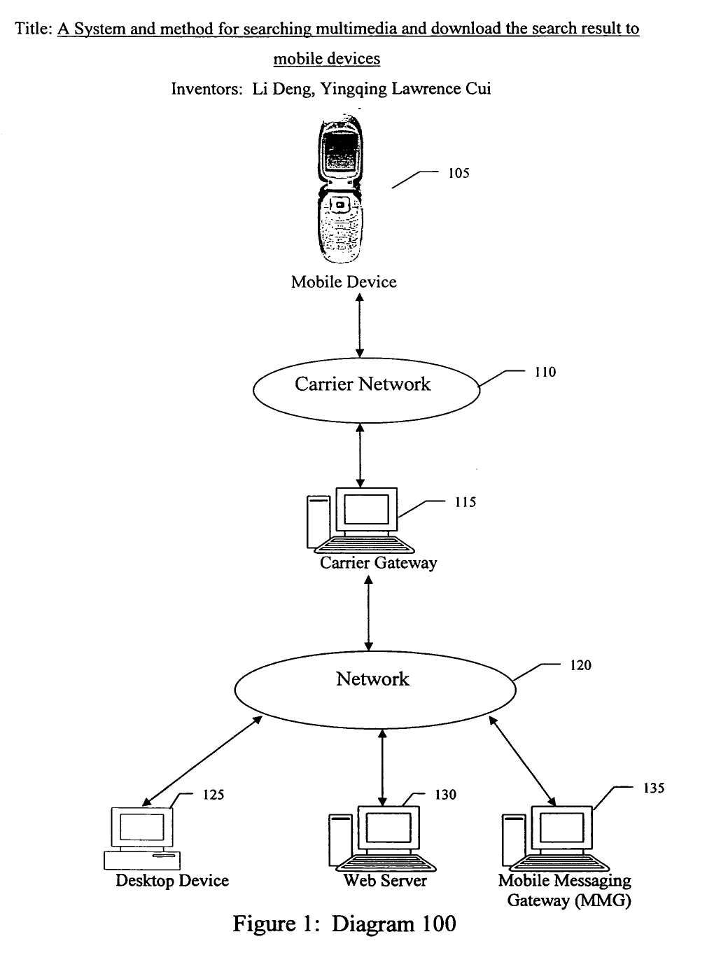

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, diagram 100 includes mobile device 105, carrier network 110, carrier gateway 115, network 120, Mobile Messaging Gateway (MMG) 135, Web Server 130, and desktop computing device 125. Carrier network 110 is in communication with mobile device 105 and Carrier Gateway 115. Network 120 is in communication with and enables communication between carrier gateway 115, MMG 135, Web Server 130, and desktop computing device 125.

Generally, mobile device 105 may include virtually any portable computing device capable of connecting to another computing device to send and receive a message. Mobile device 105 may also include other devices, such as Personal Digital Assistants (PDAs), microprocessor-based or programmable consumer electronics, wearable computers, and the like. As such, mobile devices typically range widely in terms of capabilities and features. For example, a web-enabled mobile device may have a touch sensitive screen, a stylus, and several lines of color LCD display in which both text and graphics may be displayed. Moreover, the web-enabled mobile device may include a mobile browser application enabled to receive and to send wireless application protocol messages (WAP), and the like. In one embodiment, the mobile browser application is enabled to employ WAP to fetch and display mobile markup languages such as Handheld Device Markup Language (HDML), Wireless Markup Language (WML), WMLScript, XHTML Mobile Profile, and the like.

Mobile device 105 may include a keyboard, mouse, speakers, a microphone, and an area on which to display information. Mobile device 105 may further include low-end devices that may have limited storage memory, reduced application sets, low bandwidth for transmission of a communication, and the like.

Mobile device 105 may provide a message, network packet, and the like, that includes a device identifier, such as a Mobile Identification Number (MIN). MINs are provided with each WAP request and uniquely identify each handset. Mobile device 105 may further provide a device number in addition to the device identifier. In one embodiment, mobile device 105 includes a device identification component configured to provide the MIN, phone number, and the like.

Mobile device 105 may be configured to receive a message, such as through a Short Message Service (SMS), WAP Push message, Multimedia Message Service (MMS), and the like, from the other computing device, such as MMG 135, and the like. In one embodiment, the message includes a link, such as a URL, script, executable, program, and the like. Mobile device 105 may be further configured to employ the link to request access to another piece of info, such as from MMG 135, and the like. In one embodiment, the other info is a WAP page. Multimedia, and virtually any other content type, and the like, may be accessible through the included URL, script, executable, program, and the like. For example, the content may include, but not be limited to, a document that contains multiple audio files, video files, graphics files and the like.

Mobile device 105 may further include a client application, and the like, that is configured to manage the actions described above for mobile device 105.

Carrier network 110 is configured to couple mobile device 105 and its components with carrier gateway 115. Carrier network 110 may include any of a variety of wireless sub-networks that may further overlay stand-alone ad-hoc networks, and the like, to provide an infrastructure-oriented connection for mobile device 105. Such sub-networks may include mesh networks, Wireless LAN (WLAN) networks, cellular networks, and the like.

Carrier network 110 may further include an autonomous system of terminals, gateways, routers, and the like connected by wireless radio links, and the like. These connectors may be configured to move freely and randomly and organize themselves arbitrarily, such that the topology of carrier network 110 may change rapidly.

Carrier network 110 may further employ a plurality of access technologies including, but not limited to, 2nd (2G), 2.5 (2.5G), 3rd (3G) generation radio access for cellular systems, WLAN, Wireless Router (WR) mesh, and the like. Access technologies such as 2G, 2.5G, 3G, and future access networks may enable wide area coverage for mobile devices, such as mobile device 105 with various degrees of mobility. For example, carrier network 110 may enable a radio connection through a radio network access such as Global System for Mobil communication (GSM), General Packet Radio Services (GPRS), Enhanced Data GSM Environment (EDGE), Code Division Multiple Access (CDMA), Code Division Multiple Access 2000 (CDMA 2000), Wideband Code Division Multiple Access (WCDMA), WIFI, and the like. In essence, carrier network 110 may include virtually any wireless communication mechanism by which information may travel between mobile device 105 and carrier gateway 115.

Carrier gateway 115 may include any computing device capable of connecting with mobile device 105 to enable communications with another computing device, such as MMG 135, Web Server 130, PC desktop 125, another mobile device (not shown), and the like. Such devices that may operate as carrier gateway 115 include, but are not limited to, personal computers, desktop computers, multiprocessor systems, microprocessor-based or programmable consumer electronics, network PCs, servers, and the like.

Carrier gateway 115 typically includes a carrier level service provider's computing device, and related infrastructure. Carrier gateway 115 may be configured to receive a network packet, and the like, from mobile device 105. The network packet, and the like, may include information associated with mobile device 105, such as a device identifier, and the like. The network packet may further include information associated with an end-user of mobile device 105, such as a user account identifier, and the like. Carrier gateway 115 may include additional information in the network packet prior to sending the network packet towards another device, such as MMG 135, Web Server 130, and the like. The additional information may include carrier information including, but not limited to, a carrier gateway grouping, carrier type, carrier identifier, and the like.

Carrier gateway 115 may further receive a network packet from Web Server 130, MMG 135, PC desktop 125, and the like. The received network packet may include an SMS message, a mobile browser readable message, and the like.

Network 120 is configured to couple MMG 135, Web Server 130, PC desktop 125, and the like, with carrier gateway 115. Network 120 is enabled to employ any form of computer readable media for communicating information from one electronic device to another. Also, network 120 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In essence, network 120 includes any communication method by which information may travel between carrier gateway 110, MMG 135, Web Server 130, desktop computing device 125, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal.

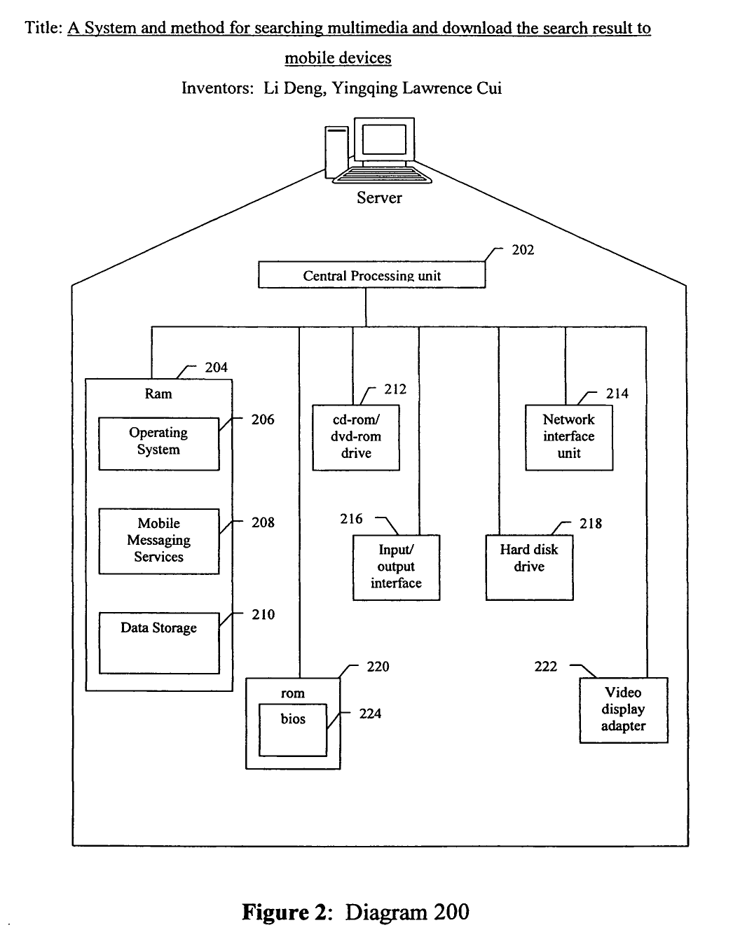

One embodiment of MMG 135 is described in more detail below in conjunction with FIG. 2. Briefly, however, MMG 135 may include any computing device capable of communicating with mobile device 105. Such devices include personal computers, desktop computers, multiprocessor systems, microprocessor-based or programmable consumer electronics, network PCs, servers, and the like.

MMG 135 may be further configured to receive a message notification associated with a message from Web Server 130. In response, MMG 135 may format a short message, such as a SMS message, MMS message, or the like, and send the formatted message towards mobile device 105. In one embodiment, the short message includes a Uniform Resource Locator (URL).

Web Server 130 may include any computing device capable of connecting to mobile device 105, MMG 135, and the like, to receive a request, process a request, and send response back to the mobile devices and the like. Such devices include personal computers, desktop computers, multiprocessor systems, microprocessor-based or programmable consumer electronics, network PCs, servers, and the like.

Web Server 130 may be configured to receive the request, for example, from PC desktop 125. Web Server 130 may determine whether the intended recipient of the message is configured to receive the message in a mobile browser readable format.

Although MMG 135 and Web Server 130 are illustrated as distinct computing devices, the present invention is not so limited. For example, the functionality of MMG 135 and Web Server 130 may be associated with a single computing device, or spread across multiple computing devices, without departing from the scope of the invention.

Desktop computing device 125 represents virtually any device enabled to make a network request to another computing device, including but not limited to Web Server 130, MMG 135. Such devices include personal computers, webcam, desktop computers, multiprocessor systems, microprocessor-based or programmable consumer electronics, network PCs, servers, and the like.

Illustrative Server Environment

FIG. 2 shows one embodiment of a server, according to one embodiment of the invention. Server 200 may include many more components than those shown. The components shown, however, are sufficient to disclose an illustrative embodiment for practicing the invention. Server 200 may represent, for example, MMG 135 of FIG. 1.

Server 200 includes processing unit 202, video display adapter 222, and a mass memory, all in communication with each other via a bus. The mass memory generally includes RAM 204, ROM 220, and one or more permanent mass storage devices, such as hard disk drive 212, tape drive, optical drive, and/or floppy disk drive. The mass memory stores operating system 206 for controlling the operation of server 200. Any general-purpose operating system may be employed. Basic input/output system (“BIOS”) 224 is also provided for controlling the low-level operation of server 200. As illustrated in FIG. 2, server 200 also can communicate with the Internet, or some other communications network, such as network 120 in FIG. 1, via network interface unit 214, which is constructed for use with various communication protocols including the TCP/IP protocol. Network interface unit 214 is sometimes known as a transceiver, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM or other optical storage, magnetic cassettes, magnetic tape, magnetic disk storage or other magnetic storage devices, or any other medium which can be used to store the desired information and which can be accessed by a computing device.

The mass memory also stores program code and data. One or more applications are loaded into mass memory and run on operating system 206. Examples of application programs include multimedia uploading programs, multimedia format converting programs, schedulers, database programs, web server programs, mobile markup language processing programs, SMS programs, MMS programs, WAP push programs, and so forth. Mass storage may further include applications such as mobile messaging service 208 and data storage 210.

Mobile messaging service 208 may further receive a mobile message, such as a message notification, indicating that a mobile device is enabled to receive a mobile browser readable message, that a message is available for the mobile device, and the like. Mobile messaging service 208 may also receive Meta information, such as an account id, WAP page identifier, and the like.

Mobile messaging service 208 may further send a short message, such as an SMS message, an MMS message, WAP push message, and the like, to the targeted mobile devices. The short message may include a link, script, executable, program, and the like that enables access to a WAP page. In one embodiment, the link is a URL that that can be invoked to download a multimedia item.

Although illustrated in FIG. 2 as distinct components, mobile messaging service 208 and data storage 210 may be arranged, combined in any of a variety of ways, without departing from the scope of the present invention. Moreover, messaging service 208 and data storage 210 may reside in one or more computing devices, substantially similar to server 200.

Server 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server 200 also includes input/output interface 216 for communicating with external devices, such as a mouse, keyboard, scanner, or other input devices not shown in FIG. 2. Likewise, server 200 may further include additional mass storage facilities such as CD-ROM/DVD-ROM drive 212 and hard disk drive 218. Hard disk drive 218 may be utilized to store, among other things, application programs, databases, WAP pages, and the like.

Search and Download Process

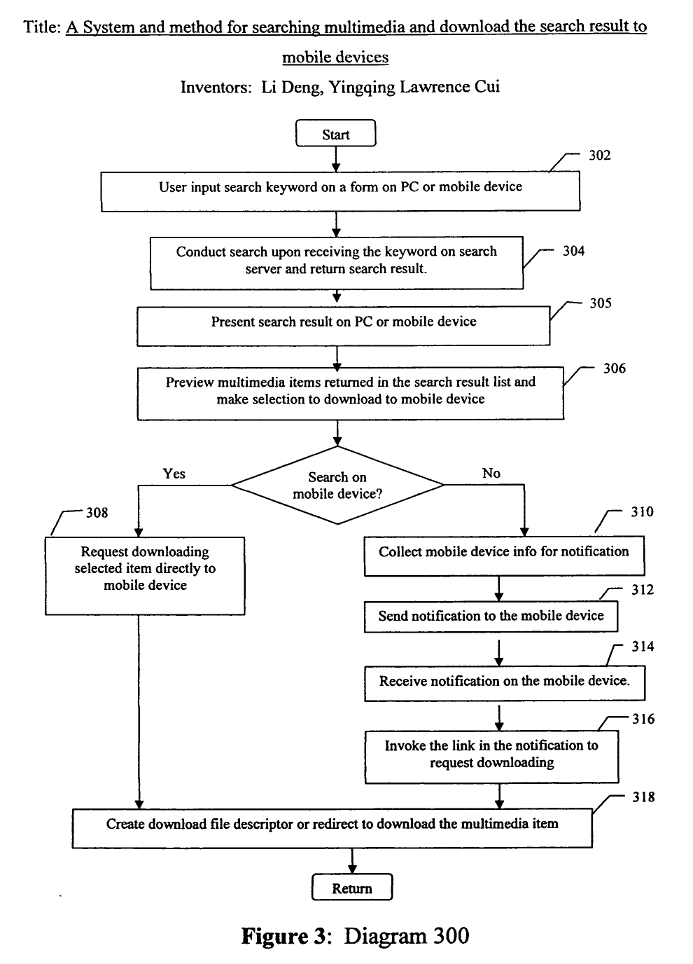

The search and download process of the present invention will now be described with respect to FIG. 3. FIG. 3 is a flow diagram generally showing one embodiment of a simplified scheme to search indexed multimedia and download the search result to mobile devices.

For ease of understanding, the process 300 employs a SMS message or WAP push message as a notification message. The notification message includes a link that can be invoked to initiate the downloading process. The record identifier of the said multimedia item is embedded in the link. However, the present invention is not so limited and virtually any mobile messaging vehicle may be employed to deliver the notification. Additionally, virtually any link may be employed to initiate the downloading process, including a URL, a script, an executable, a program, and the like.

The process 300 begins, after a start block, at block 302, where users input search keywords and optional criteria such as content type, mobile device model to locate desired multimedia files to be downloaded to the user's mobile device.

Processing continues to block 304 where the search server conducts a search using keywords and optional criteria such as content type, mobile device model against records for indexed multimedia items. Processing continues to block 305, where the search result is then returned and presented to user. For each item in the search result list, a preview link, a send to phone link if the search is conducted from PC or a download link if the search is conducted from mobile device are presented to user. The record identifier for the multimedia item is included in the links. Processing continues to block 306, where the user can preview multimedia items returned and make a selection to download desired multimedia item.

If the user uses the mobile device to conduct the search, the processing continues to block 308, where the user can select and download an item directly to the mobile device. The user can select an item and press the download link to initiate downloading process. Once the download request is received on the download server, it retrieves the gateway ip address hat is sent as part of the http request from the mobile device. The service provider info can then be looked up using the gateway ip address. The delivery method and requirements can then be queried from the database by using the service provider info. If the service provider requires a download file descriptor to download the multimedia, a download file descriptor is created on the delivery server and returned to the mobile device. The size, the type, and the destination url of the selected multimedia item are included in the file descriptor. If a download file descriptor is not required for downloading, the mobile mini browser is redirected to the destination url of the selected multimedia item. The mobile device then download the selected multimedia item using the multimedia url that points to 3^{rd} party multimedia content site.

If the user uses a desktop PC to conduct the search, processing continues to block 310 where the user is prompted to enter mobile device info such as phone number for downloading the selected multimedia item. Processing continues to block 312, where a notification message is created and sent to the said mobile device. The notification message contains a link that includes the record identifier for the selected multimedia item. Processing continues to block 314, where notification message is received on the mobile device. At block 316, the notification message is opened and the link is invoked to download the selected multimedia item. The service provider info is then inferred from the gateway ip address that is sent as part of the http request from the mobile device. The delivery method is queried from the database by using the service provider info. If the service provider requires a download file descriptor to download the multimedia, a download file descriptor is created on the server and returned to the mobile device. The application management system on the mobile device then parse the file descriptor to get the meta data info such as the size, the type, and the url of the selected item. If a download file descriptor is not required for downloading, the mobile mini browser is redirected to the multimedia destination url to download the multimedia item. The mobile device then downloads and saves the selected multimedia item from the multimedia url that points to the multimedia file resides at 3^{rd} party multimedia content site.

Logical Components and Data Flow

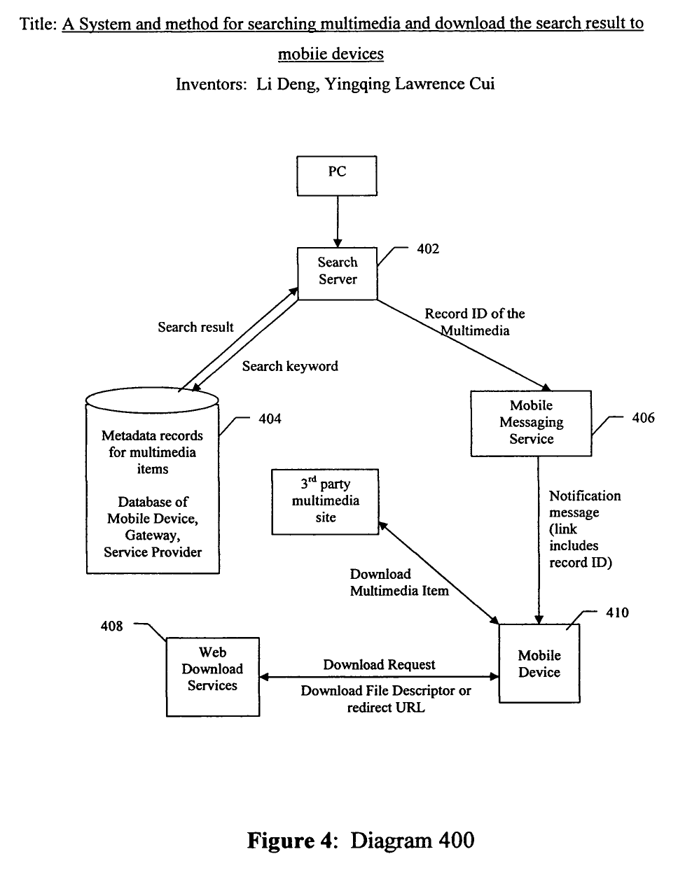

When search is conducted from a desktop PC, FIG. 4 illustrates logical components and data flow that may be involved during the processes specified in FIG. 3. As shown in the figure, the diagram 400 includes search server 402, data storage server 404 for records of indexed multimedia items, records of mobile devices and service providers, mobile device 410, Web Download Service 408, and Mobile Messaging Service 406.

Web Download Service 408 may operate as a component within Search Server 402, or operate within another computing device, or as a combination of MMG 135 and the other computing device.

Search Server 402 handles all search requests from PCs and from data capable mobile devices. In one embodiment, Search Server 402 is enabled to conduct a search using the collected keywords, optional content type or device model, against the indexed records in data storage 404. The search Server 402 then returns the search result to the user. For each item in the search result list, a preview link and a send to phone link are also provided to user. User can then preview the multimedia items returned in the search list and make a selection to download the desired item. Upon selecting an item for downloading, the search server 402 first collects mobile device info from user, and then instructs the mobile messaging service 406 to send a notification message to the mobile device.

Mobile messaging service 406 finds the messaging address (such as SMS or WAP push addresses) associated with mobile device numbers, generates and delivers notification message to mobile devices. Upon receiving the notification request from Search Server 402, along with the record identifier of the selected multimedia item, the mobile messaging service 406 then generates a notification message, such as an SMS message, and the like, that includes a link, such as a URL. The link includes the record identifier of the selected multimedia item. Mobile messaging service 406 then finds the messaging address (such as SMS or WAP push addresses) of mobile device 410 by querying the service provider database using mobile device numbers and looking up the domain routing table. The notification message with an embedded link, and the like, is sent to messaging address (such as SMS or WAP push addresses) associated with mobile device 410.

Mobile device 410 invokes the link embedded in the notification message and sends a request to Web Download Service 408 to initiate the downloading process. The request includes the record identifier of the selected multimedia item. Mobile device 410 may also send its device identifier to Web Download Service 408.

Web Download Service 408 receives the request for downloading from the mobile device. Web Download Service 408 collects the IP address and device info from the request. Web Download Service 408 further queries the mobile device and mobile network database for download method and other download requirements. If a file descriptor is required, Web Download Service 408 then creates a download file descriptor using the record identifier of the selected multimedia item and then returns the file descriptor to the device. Mobile device 410 then parses the download file descriptor to find the multimedia url, and uses the url to download the multimedia item from 3^{rd} party site that hosts the multimedia file. If download file descriptor is not required, Web Delivery Download 408 finds the url of the multimedia item using the record identifier and then redirects the mini browser to the multimedia url. Mobile device 410 then follows to the url to download the multimedia item.

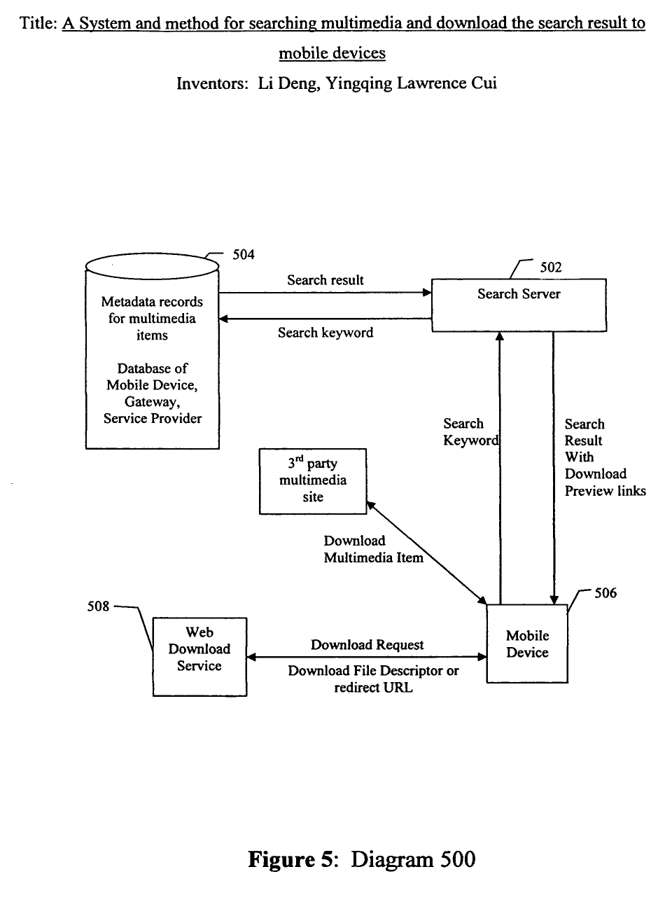

When search is conducted from a mobile device, FIG. 5 illustrates logical components and data flow that may be involved during the processes specified in FIG. 3. As shown in the figure, the flow 500 includes search server 502, data storage server 504 for records of indexed multimedia items, records of mobile devices and service providers, mobile device 506, and Web Download Service 508.

Web Download Service 508 may operate as a component within Search Server 502, or operate within another computing device, or as a combination of MMG 135 and the other computing device.

In one embodiment, Search Server 502 is enabled to conduct a search using the collected keyword against the indexed records in data storage 504. The search Server 502 then returns the search result to mobile device 506 that initiated the search. For each item in the search result list, a preview link and a download link are also provided to user. User can then preview the multimedia items returned in the search list on a mobile device or download the desired item. Upon user selecting an item for downloading, mobile device 506 sends a download request to Web Delivery Download 508 to initiate the downloading process. The request link includes the record identifier of the selected multimedia item. Mobile device 506 may also send its device identifier to Web Download Service 508.

Web Download Service 508 receives the request for downloading from the mobile device. Web Download Service 508 collects the IP address and device info from the request. Web Download Service 508 further queries the mobile device and mobile network database for download method and other download requirements. If a file descriptor is required, Web Download Service 508 then creates a download file descriptor using the record of the selected item and then returns the file descriptor to the device. Mobile device then parses the download file descriptor to find the multimedia url, and uses the url to download the multimedia item from 3^{rd} party site that hosts the multimedia file. If download file descriptor is not required, Web Download Service 508 finds the multimedia url using the record identifier and redirects the mini browser to the multimedia url. Mobile device then follows to the url to download the multimedia item.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A system and method to enable mobile users to find multimedia items located on the internet and download to their mobile devices, the system and method comprising:
At least one crawling server in data connection with the internet;
At least a data storage server in communication with the internet;
At least one search server in communication with the internet;
At least one download server in communication with the internet;
At least one messaging server in communication with the internet and wireless messaging gateway;
Wireless devices in communication with internet via wireless application protocol;
Mobile device information records;
Gateway Information records;
Service provider records;
Operating crawling server to index multimedia items;
Searching against the records of indexed multimedia items from both PC and mobile devices;
Previewing search results;
Sending search results to mobile devices;
Downloading desired items returned in the search result list to mobile devices.

2. The system of claim 1, wherein the device info records include supported multimedia MIME types/formats, the maximum size/length of multimedia for supported types, and the display screen sizes of mobile devices.

3. The system of claim 1, wherein the gateway info records include IP addresses for service providers.

4. The system of claim 1, wherein the service provider records include provider names, delivery options, and download requirements for service providers. Available delivery options are WAP, MMS, or both. Delivery requirements include download file descriptor or redirect.

5. The method of claim 1, wherein the crawling step includes:
Identifying content sites to crawl multimedia items;
Fetching the web pages;
Finding multimedia items on a web page;
Parsing keywords and media url for each multimedia item;
Determining the size/length and type/format of a given multimedia;
Creating a metadata record including web page url, multimedia url, media type/format, media size/length, media keywords;

6. The method according to claim 5 wherein the finding multimedia steps further includes the step of analyzing a web page and detecting multimedia items.

7. The method according to claim 1 wherein the searching step includes: presenting a form to collect keyword and optional multimedia type or mobile device model; conducting a search against indexed multimedia; presenting search result.

8. The method of claim 7 wherein providing options for searching from both desktop PC and mobile devices.

9. The method of claim 7 wherein the search result is compared against Device information database to filter out items not supported by a given mobile device model if such model has been provided by user as a search criteria.

10. The method of claim 7 wherein each item in the search result is associated with a preview link and/or a send to phone link if the search is conducted on a desktop PC. All the links include the record identifier of the said multimedia item.

11. The method of claim 7 wherein each item in the search result is associated with a preview link and/or a download link if the search is conducted on a mobile device. All the links include the record identifier of the said multimedia item.

12. The method according to claim 1 wherein the sending to phone step further includes: presenting a form to collect mobile device number and optional service provider or mobile device model; generating a notification message; delivering the notification message to the said mobile device.

13. The method of claim 12 wherein a link that includes multimedia record identifier is embedded in the notification message; the link can be invoked to download the multimedia item.

14. The method of claim 12 wherein the notification message can be delivered via a delivery option for the specified carrier, including SMS message, WAP push message, or any wireless message construct.

15. The method according to claim 1 wherein the downloading process includes: sending a download request with multimedia record identifier to server from a mobile device; inferring download method from the download request; fulfilling the downloading requirements per download method on the server; downloading the multimedia on the mobile device;

16. The method according to claim 15 wherein the downloading process can be initiated by either invoking the link embedded in a notification message or selecting the download option presented in the search result via a search session on mobile device.

17. The method according to claim 15 wherein the inferring download includes: collecting IP from the download request; looking up service provider by gateway IP address; looking up download method by service provider.

18. The method according to claim 15 wherein the fulfilling downloading requirements further includes one of the followings: (a) querying the multimedia url by the record identifier, creating a download file descriptor and returning it to mobile device; (b) querying the multimedia url by the record identifier and redirecting the mobile device to the multimedia url; (c) querying the multimedia url by the record identifier and fetching the multimedia item on the server, and then sending a MMS message to the mobile device.

19. The method according to claim 15 wherein completing the download process includes one of the following 3 steps on the mobile device: parsing the download descriptor file to get the multimedia url and downloading the multimedia using the url; following the redirect url to download the multimedia; downloading the MMS.

20. The method according to claim 15 wherein a download file descriptor includes info about the MIME type of the said multimedia item, the size, and the url for the said multimedia item.
